(19) United States
(12) Patent Application Publication
(10) Pub. No.: US 2004/0055204 A1
(43) Pub. Date: Mar. 25, 2004

(54) Lite pole

(76) Inventor: David Wayne Allie, Roanoke, VA (US)

Correspondence Address: David Wayne Allie, 5397 Vistamont Dr., Roanoke, VA, 24019, US

(21) Appl. No.: 10/183,763

(22) Filed: Sep. 19, 2002

(51) Int. Cl. A01K 87/00

(52) U.S. Cl. 43/18.1 R

(57) ABSTRACT

The appealing features of the “Lite Pole” would be its ability to enable a fisherman to see his rod while fishing at night without having to use a separate light or lantern. The “Lite Pole” would also increase convenience and enjoyment for a fisherman. The illuminated rod would be easy to see from a distance. This would allow the fisherman to get up, walk around without the fear of missing a strike. The light would make the rod easy to find in the dark.

For increased appeal, the “Lite Pole” could be produced in various common styles, colors, lengths, actions to provide a rod that would be suitable for many types of fishing. Each rod could be used with a conventional reel and because a LED light or a pen like flashlight is used it adds very little weight to the rod. So its performance would not be significantly altered.

A pole that is an improvement over existing fishing poles used for night fishing. It has no external or internal wiring. When turned on the entire shaft lights up. The light element used and its power source are in the handle of the pole. The light element can be that of a LED (Light Emitting Diode) or a regular pen like flashlight bulb that are of varying colors to compensate for the color of the poles.

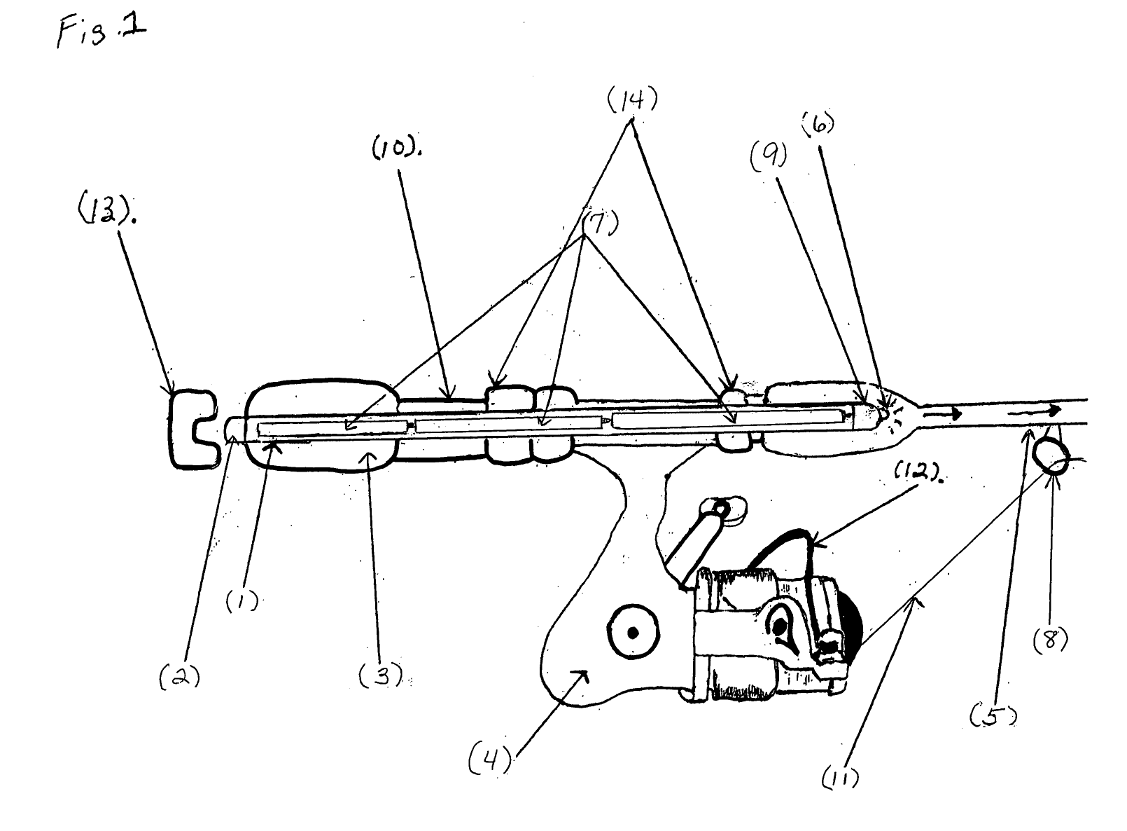

### FIG. 1

1. Pen like flashlight or LED (Light Emitting Diode) that is in the shaft of the handle. This is the source of light.

2. Switch on and off for light.

3. Rubber type sponge handle

4. Reel

5. Translucent colored pole. Made of fiberglass and is light weight. Can use may different color poles.

6. Protective lense for bulb.

7. Battries inside case. Can use double A's, triple A's or quad batteries depending on light used.

8. Eyes that fishing line goes through.

9. Led light or pen like fashlight bulb.

10. Reel handle

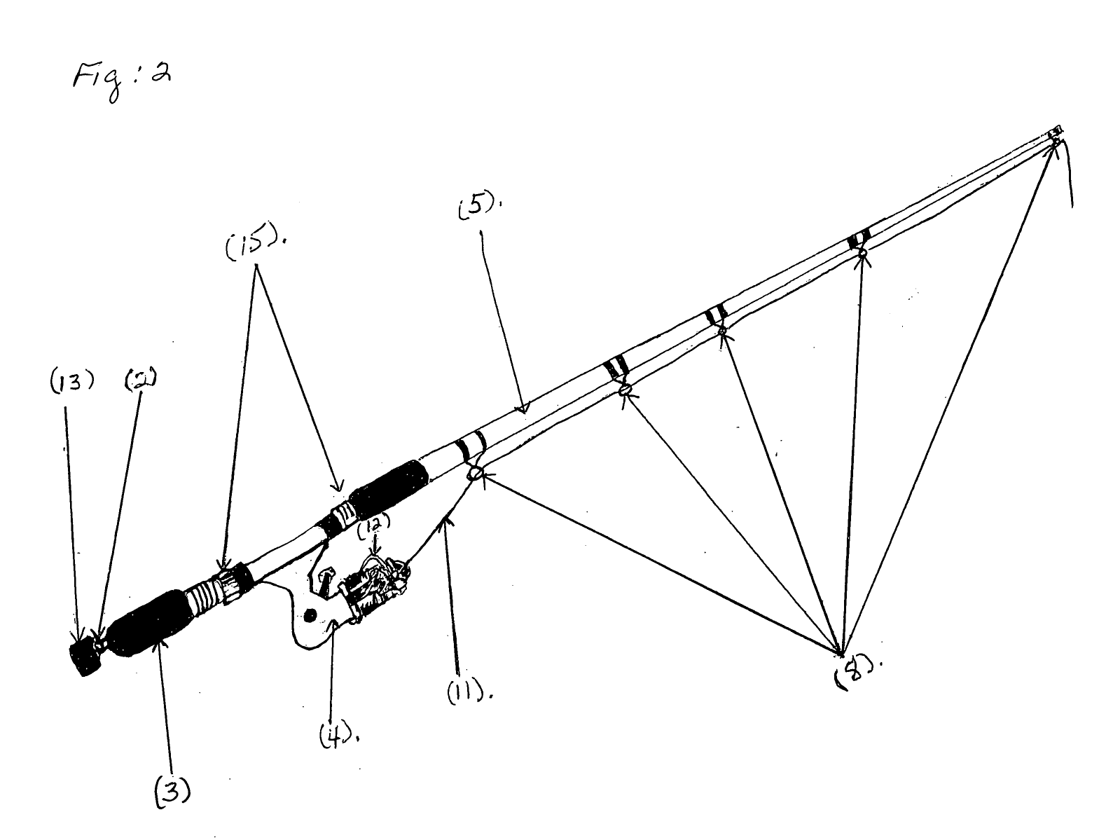

### FIG. 2

1. Rubber cap

2. On and off switch

3. Handle

4. Reel

5. Line spool

6. Fishing line

7. Fishing line eye gides

8. Translucent colored pole

9. Rell tightening nut

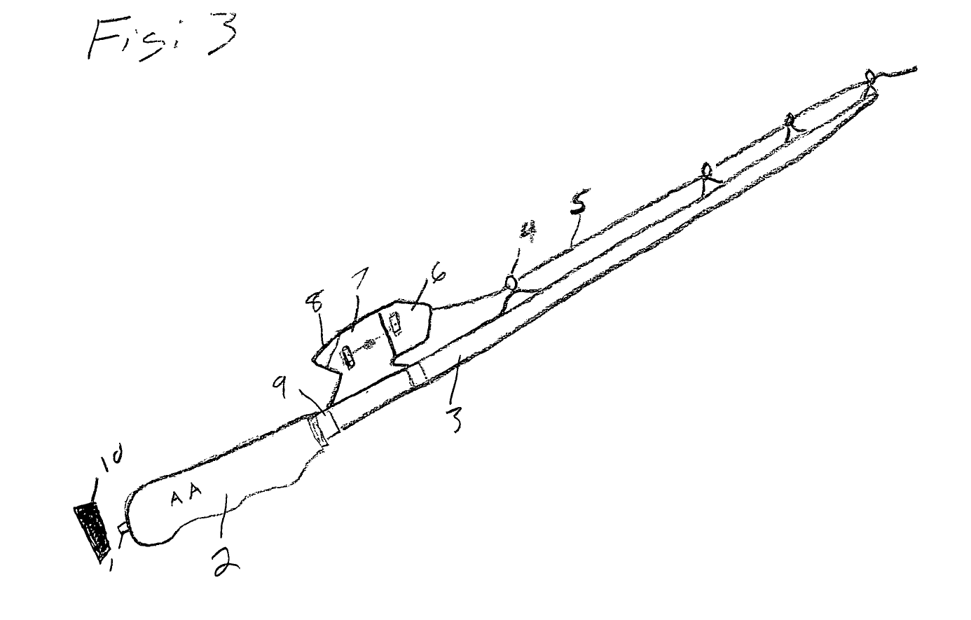

### FIG. 3

1. On and off switch

2. Handle

3. Translucent colored pole

4. Fishing line eye gides

5. Fishing line

6. Fishing line spool cap

7. Reel

8. Casing button

9. Screw clamps

10. Rubber cap

My Lite Pole is a better method of lighting a fishing pole, for the purpose of fishing at night. I use LED lights and pen like flashlight that fit into the handle and it is very bright. These lights require triple A, double A or quad A batteries. It is a very affordable and comes in all basic colors.

A flashlight pen or a LED light is installed inside the handle of pole. A hollow fiberglass rod is used. This enables the light to travel from inside the handle, up inside the hollow rod clear to the end. Their for the hole pole lights up. The pole is light weight, because it is made of fiberglass. The source used for lighting is also lightweight. The light source is easy to remove to change the batteries. The Lite Pole is very economical. So everyone can enjoy it.

1. I claim that my pole is very unique and up to date. It is light weight, but firm. The pole is made of a translucent fiberglass. It comes in many colors.

2. In the handle I have put a LED light or a pen like flashlight. Which comes in different colors.

3. The LED light bilb last up to 100,000 hours. These lights use double A or Triple A or A quad battries.

4. The light travels up the handle. This makes the whole rod light up.

5. If a clear reel is used. A small hole can be put where reel attaches to pole. This will also make the top part of the reel light up. So you can see this at night also.

6. At the end of the handle is a cap. To protect the light inside handle.
